(19) United States
(12) Patent Application Publication
(10) Pub. No.: US 2008/0059368 A1
(43) Pub. Date: Mar. 6, 2008

(54) Direct Passthrough System for Financial Contributions

(76) Inventor: Mark Andrew Boys, Aromas, CA (US)

Correspondence Address: CENTRAL COAST PATENT AGENCY, INC, 3 HANGAR WAY SUITE D, WATSONVILLE, CA, 95076, US

(21) Appl. No.: 11/931,267

(22) Filed: Oct. 31, 2007

Related U.S. Application Data
(63) Continuation of application No. 11/414,281, filed on Apr. 27, 2006.
Application No. 11/414,281 is a division of application No. 10/016,831, filed on Dec. 12, 2001.

(51) Int. Cl. G06Q 40/00; G06F 17/30

(52) U.S. Cl. 705/39

(57) ABSTRACT

A system for direct donation utilizes an Internet-connected server accessible by potential donors using an Internet browser and a data store accessible to the server and storing information about potential recipients pre-qualified for donations. A software suite executing on the server has at least a first facility enabling a potential donor to view specific information about qualified recipients of donations, and a second facility enabling the same donor to select a recipient and make a direct donation to the selected recipient.

### FIELD OF THE INVENTION

The present invention is in the field of network-based systems, and pertains more particularly to an Internet system for directly linking contributors and victims of disasters.

### BACKGROUND OF THE INVENTION

The inventor believes that Americans in particular and most people in general who have enough for themselves and some to spare are famously generous people, ever ready to contribute to others less fortunate. The record of charitable giving in the US in particular overwhelmingly supports this belief. For example, at the time of this application, well over 1 billion dollars has been contributed, mostly by Americans, to help the victims of the WTC attack. The record of giving in other cases of severe loss is also notable.

Still, given the generosity and ability of Americans to support victims of disasters, there are many problems attendant to the process of eliciting contributions and funneling the proceeds to the deserving. In the case of the WTC there has been considerable controversy, for example, in the handling of money solicited by the American Red Cross (ARC) for victims of the WTC attack. The subject has become a cause celebre of certain Television personalities, who have questioned the handling of money by the ARC, and the portion of contributions that is actually being distributed to the victims, versus the portion marked to be retained for administrative expenses and future contemplated needs.

As of the date of this application, the matter of the ARC has been largely settled by their decision to apply a much greater portion of the aggregate contributions to funds directly to the victims. Still, the logistics of the process leave a lot to be desired. In the current art solicitation of contributions from individuals and organizations, the management of funds received, and the distribution of those funds, or portions thereof, to qualifying persons or organizations id managed by non-profit organizations who advertise their particular causes, solicit funds, accept contributions, manage the money, and make distributions. It is a relatively complicated process marked by an organization, such as the Red Cross or any other of the many charitable concerns, that stands between the contributor and the recipient of any aid.

The seemingly necessary disconnection of the contributor and the recipient is the source of many problems on both sides, as well as for the organization in the middle. Potential recipients of aid typically, for example, have to travel to the business offices of the charitable organization to undergo application and verification of both need and eligibility. This can be a difficult and sometimes humiliating process, particularly for people grieving the recent loss of loved ones, and facing a difficult future. It is inevitable that such people may become angry, hurt, and distrustful. They must often feel at the mercy of the organization in the middle.

For the potential contributors there is also an inevitable distrust, especially if there is a perceived message in the solicitation that later appears to be not true. The inventor believes that this hesitation may be a barrier to even more generous responses by potential givers. Another problem for potential contributors is that, even if they are comfortable with the portion or percentage of their contribution that will go to the cause, there is typically no way to specify a particular recipient or organization that will receive the contribution. There may, for example, be particulars persons or groups involved that would be particularly interesting to potential contributors, and these contributors might be more forthcoming if they could specify the use of their own contribution. Further, the inventor believes that many people have come distrust the whole process, and therefore refrain from making contributions.

For the organizations who endeavor to meet the needs, and provide the necessary pipeline between the contributor and the recipient, these problems of potential distrust and transparency on both sides are difficulties as well.

Clearly what is needed is a system that can directly connect, in times of need precipitated by disasters like the WTC attack and the downing of American flight n587 in Queens, N.Y., potential contributors and qualifying victims of such disasters, largely eliminating the organization in the middle, so people may in confidence quickly and reliably funnel money to individual people and organizations in need. The system needs to be structured in a way that victims can avoid the stigma of having to submit to interrogations, and contributors can select victims and organizations in a manner that contributions may be made directly to individuals and specific groups, without any pooling and management in the middle.

A system to solve the problems detailed above is taught in enabling detail below.

### SUMMARY OF THE INVENTION

In a preferred embodiment of the present invention a system for direct donation is provided, comprising an Internet-connected server accessible by potential donors using an Internet browser, a data store accessible to the server and storing information about potential recipients pre-qualified for donations, and a software suite executing in the server, comprising at least a first facility enabling a potential donor to view specific information about qualified recipients of donations, and a second facility enabling the same donor to select a recipient and make a direct donation to the selected recipient.

In one preferred embodiment qualified recipients are organized into project groups, and projects are listed for a potential donor as selectable entities, which, when selected, allow the donor to view information about qualified recipients associated with the selected project. There may also be an interactive voice response (IVR) system through which a recipient may interact with the system by telephone.

In some embodiments there is a third facility for interacting with financial institutions, wherein a donation initiated by a donor for a selected qualified recipient results in a withdrawal of the donation amount from an account associated with the donor and a deposit to an account associated with the qualified recipient. In this embodiment there may be a fourth facility for setting up accounts at financial institutions for donors and recipients, and a fifth facility for displaying account details on demand to either of donors and recipients.

In preferred embodiments of the invention there is a qualification facility interacting with potential recipients of donations and qualifying potential recipients as qualified recipients, which are then presentable by the system to potential donors.

In alternative embodiment there is a sixth facility providing non-cash donations to qualified recipients for cash donations made by donors. In some embodiments the non-cash donations are made in the form of documents redeemable at pre-qualified and cooperating sites for goods and services. The documents may take the form of cards issued for a total amount and redeemable in portions of the total amount until the total amount is redeemed, and the documents may be associated with specific recipients by an identification procedure, and may be non-transferable. One identification procedure involves creating a virtual identity for a recipient, and issuing a second document bearing the virtual identity, which must be associated with the redeemable document to implement redemption of any portion of the associated donation.

In another aspect of the invention a method for direct donation is provided, comprising the steps of (a) providing an Internet-connected server accessible by potential donors using an Internet browser; (b) providing a data store accessible to the server and storing information about potential recipients pre-qualified for donations; and (c) executing a software suite in the server, enabling a potential donor by a first facility to view specific information about qualified recipients of donations, and a by second facility to select a recipient and make a direct donation to the selected recipient.

In preferred embodiments of the method qualified recipients are organized into project groups, and projects are listed for a potential donor as selectable entities, which, when selected, allow the donor to view information about qualified recipients associated with the selected project. There may also be an interactive voice response (IVR) system through which a recipient may interact with the system by telephone.

In some embodiments of the method a third facility is provided for interacting with financial institutions, wherein a donation initiated by a donor for a selected qualified recipient results in a withdrawal of the donation amount from an account associated with the donor and a deposit to an account associated with the qualified recipient. In this embodiment there may also be a fourth facility for setting up accounts at financial institutions for donors and recipients. A fifth facility displays account details on demand to either of donors and recipients.

In some embodiments of the method a qualification facility interacts with potential recipients of donations and qualifies potential recipients as qualified recipients, which are then presentable by the system to potential donors.

In an alternative embodiment of this method a sixth facility provides non-cash donations to qualified recipients for cash donations made by donors. The non-cash donations are made in preferred embodiments in the form of documents redeemable at pre-qualified and cooperating sites for goods and services. The documents may take the form of cards issued for a total amount and redeemable in portions of the total amount until the total amount is redeemed. Further, in some embodiments documents are associated with specific recipients by an identification procedure, and are non-transferable. In some cases the identification procedure comprises creating a virtual identity for a recipient, and issuing a second document bearing the virtual identity, which must be associated with the redeemable document to implement redemption of any portion of the associated donation.

In embodiments of the invention taught in enabling detail below, for the first time a system is provided that enables donors to make donations specifically to individual ones of persons or groups qualified to receive donations, and to provide the service in a way that donors can be sure that their donations are actually going to people who need the donations.

### BRIEF DESCRIPTION OF THE DRAWING FIGURES

FIG. 1 is an overview of a network-connected donation system according to an embodiment of the present invention.

FIG. 2 is an illustration of a top-level menu page for the system of FIG. 1.

FIG. 3 is a page for displaying lists of qualified recipients in a project selected from FIG. 2.

FIG. 4 is an information page displayed as a result of selecting a recipient from FIG. 3.

FIG. 5 is a Donation page for entering and accomplishing a donation in an embodiment of the invention.

FIG. 6 is a page or window providing detail about a donor's account in an embodiment of the invention.

FIG. 7 is a page or window providing detail about a recipient's account in an embodiment of the invention.

FIG. 8 is a page or window for selecting form of communication with a recipient in an embodiment of the invention.

### DESCRIPTION OF THE PREFERRED EMBODIMENTS

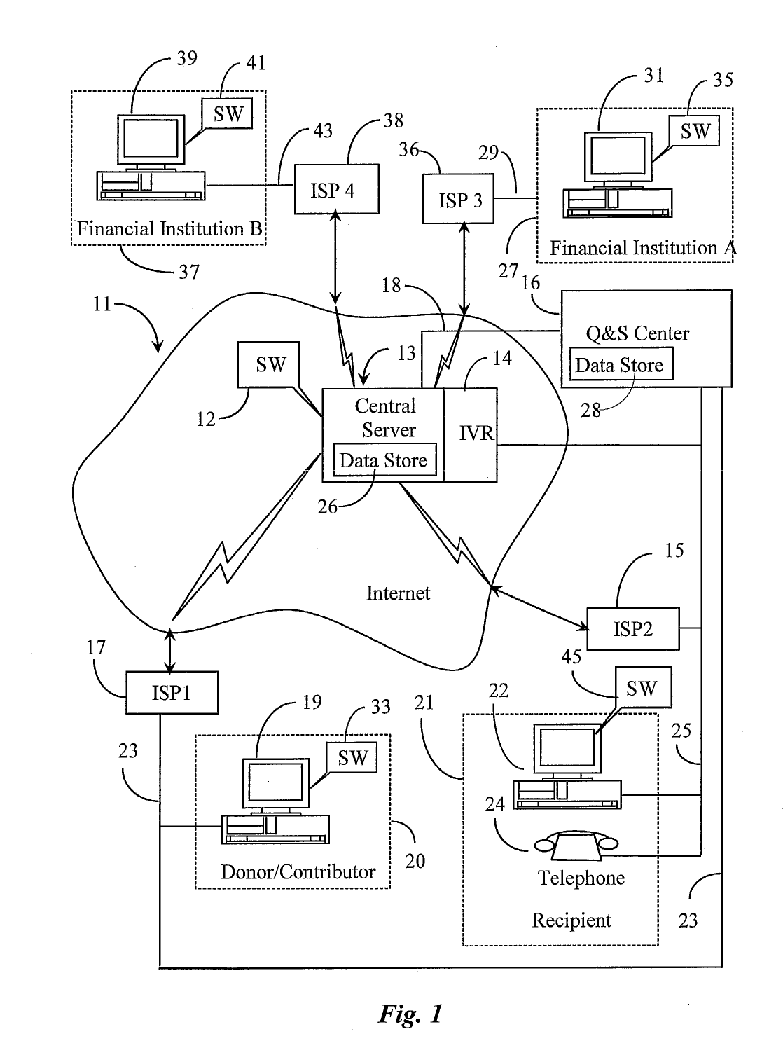

FIG. 1 is an overview of a network-connected system according to an embodiment of the present invention. In this system a central server 13 is a Web server in the well-known Internet network 11, and special functions unique to embodiments of the invention are provided in the main by software 12, operating in part on data in a data store 26. Data store 26 is illustrated as internal to server 13, but may be any convenient sort of data storage available to the server. In a preferred embodiment server 13 provides an ability for direct connection between potential recipients of aid and potential contributors, allowing at least an ability for potential contributors to access details pertinent to individual ones of the potential recipients, and an ability to contribute directly to selected ones of the potential recipients. In alternative embodiments a facility for two-way communication between contributors and recipients is also made.

An important object of the invention is to make possible direct contribution, wherein financial aid is passed through, without any monies being delayed, pooled, or retained in the name of the host of the server system.

In FIG. 1, station 20 represents a station used by one of many contributors, and a personal computer (PC) 19 having software 33 is the preferred mechanism for the contributor to interact with server 13. In this example the station has a telephone line 23 to an Internet Service Provider (ISP 1) 17 to provide Internet access, and software 33 includes at least a conventional browser, such as Microsoft Explorer™. It will be apparent to the skilled artisan that there are many equivalent ways that a potential contributor might access and interact with server 13.

Station 21 is a station used by one of a plurality of recipients, and is enabled by a PC 22 executing software 45 connected by a telephone line to ISP 2, element 15, to Internet 11, hence server 13, and again, software 45 includes at least a conventional browser for Internet navigation and interaction. Again, the skilled artisan will recognize that this arrangement is exemplary, and may be accomplished in other conventional ways. Station 21 also includes a telephone 24 by which a person using the station (a recipient of aid through server 13) may communicate with an IVR 14 which is a part of server 13. In an alternative embodiment there may also be live agents associated with server 13, and communicants with the server may interact with the live agents.

In addition to interaction with potential contributors and recipients, there are shown in FIG. 1 two financial institutions A and B, labeled elements 27 and 37, each of which is enabled to communicate and interact with server 13 via ISPs 36 and 38 respectively. Station 27 is illustrated as comprising a PC 31 and software 35, and station 37 comprises a PC 39 and software 41. Again, this infrastructure is exemplary only, and the skilled artisan will recognize that financial institutions may be Internet-capable in a number of conventional ways. The purpose and involvement of the financial institutions is described in additional detail below.

Also illustrated in FIG. 1 is a qualification and structure (Q&S) facility 16 which serves as a work center wherein potential recipients of aid through central server 13 may be qualified and integrated to projects, new projects may be organized and structured, and regular updates in the infrastructure of server 13 may be made, among other important organization and maintenance tasks. The structure and involvement of Q&S facility 16, which in one preferred embodiment has a data store 28 and is connected to server 13 by a high-speed data link 18, is described also in additional enabling detail below.

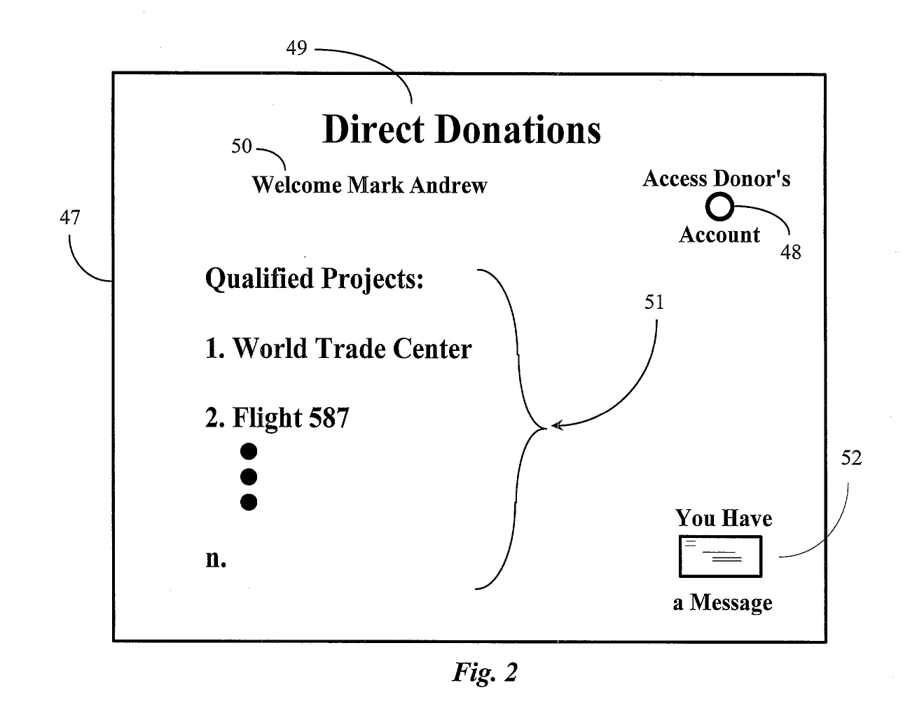

In a preferred embodiment of the invention a potential contributor may use a station such as station 20 illustrated to gain Internet access and to access Web server 13. Typically, when a person browsing the Web asserts a URL and accesses a server on the Web, the server presents a log-in page to the person, as is well-known in the art, and persons may become subscribers to the system by selecting a user name and a password, and using that combination in future to log in. After successful log in, a top-level page is presented to the PC used by the person, which, by virtue of the browser used by PC 19 displays the page on the display of PC 19. In a preferred embodiment of the present invention, asserting the URL of server 13, and successfully logging in, the potential contributor will see a page such as that represented by FIG. 2.

The top-level display 47 in a preferred embodiment of the present invention provides a Host Name 49, in this case indicated as Direct Donations, and an interactive list 51 of one or more qualified projects 1 through n. Each of the project listings in a preferred embodiment is an active hyperlink that takes the potential contributor to a lower-level page associated specifically with the link selected. In preferred embodiments certain data on both regular donors and recipients is maintained in profiles in databases accessible by the system of the invention, and that data may be automatically accessed and used to provide enhanced services. For example, if a donor that has been previously qualified accesses the top-level page of the system, that donor may be addressed, as shown in header 50 “Welcome Mark Andrew”. Further, if that donor has authorized and helped to configure a special donor's account, a process taught below in this specification, there will be an interactive link 48 which the donor may use to access and review that account.

The skilled artisan will recognize that the structure illustrated is exemplary, and there may be more hierarchical structure, the links may be icons or dynamic displays, rather than textual phrases as shown, and so on.

In a preferred embodiment, when a potential contributor activates a link associated with a listed project, a lower-level URL is asserted. In some cases the lower level page will be a hierarchical listing providing an intermediate step in selecting a final destination. In other cases the potential contributor will arrive at a page listing a plurality of individuals, families, and organizations that qualify as recipients of contributions for the project selected.

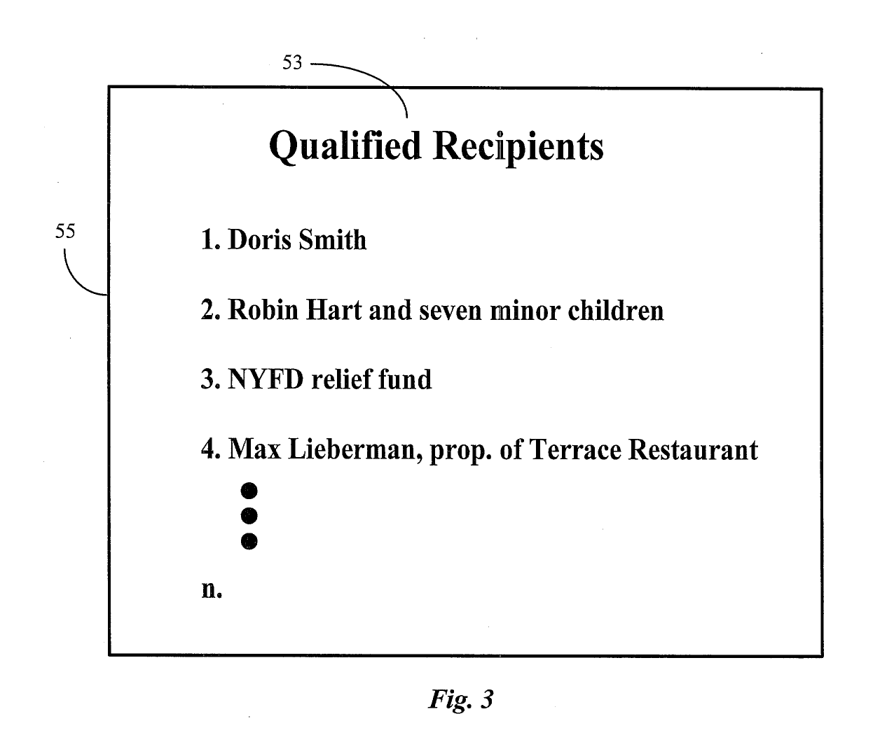

FIG. 3 is an example of a lower-level page 55 that is presented in one embodiment when a hyperlinked project listing is selected in the list of FIG. 1. In this particular example it is assumed that Project No. 1 (World Trade Center) is selected. A header 53 “Qualified Recipients” is provided, and in this simplified example separate entities are listed as qualified recipients in the WTC project, and each of these listings is also a hyperlink. Qualified recipients can take any one of several forms. A qualified recipient, for example, may be an individual, such a Doris Smith, listed as recipient No. 1 in FIG. 3. The qualified recipient may be a family, as illustrated by No. 2 in FIG. 3, such as Robin Hart and her seven minor children. The recipient may be an organization, such as the relief fund listed as No. 3. Still further, a qualified recipient may be a person such as Max Lieberman listed as No. 4, who lost his business in the attack on the WTC. The skilled artisan will recognize that “Qualified Recipient” may take any of a wide variety of forms, and there is no practical limit to the definition of a qualified recipient, depending on the project.

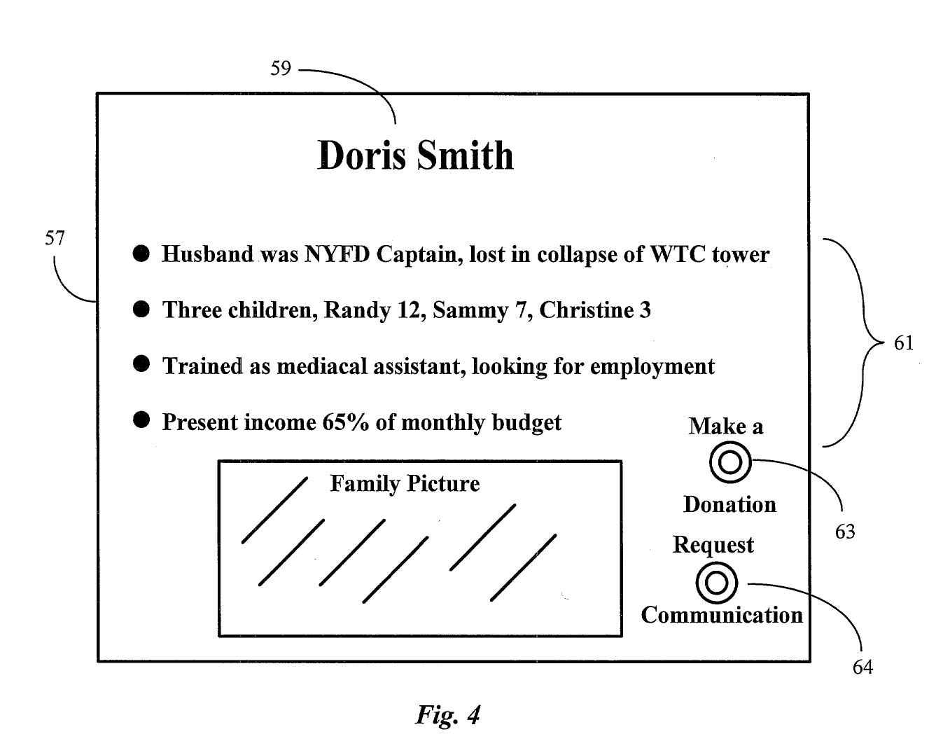

FIG. 4 is an example of a next-level page 57 displayed as a result of selecting one of the hyperlinks in page 55, in this example No. 1 for “Doris Smith”. This level is an information page dedicated to specific information about the qualified recipient selected in page 55 shown in FIG. 3. A header 59 identifies the recipient Doris Smith. A bulleted list 61 provides information about Doris Smith; and a family picture 65 is provided as well in this example. The skilled artisan will recognize that the format and information shown is exemplary only, and may be much more extensive and detailed than that illustrated in FIG. 4.

On each page at the level of page 57, reached as a result of selecting a hyperlinked one of the listed qualified recipients ion page 55, there is in this example a “Make a Donation” hyperlinked icon 63. A browsing potential donor may, of course, visit any number of information pages, and need not make any donation, or the donor may make a donation through any number of information pages.

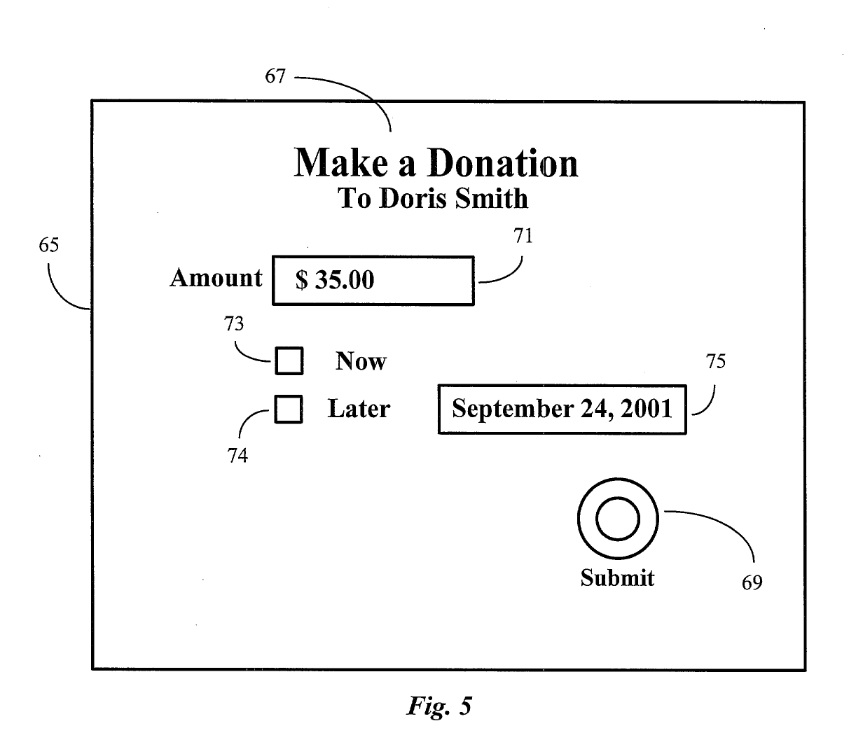

In this embodiment, selecting a “Make a Donation” hyperlink 63 on an information page takes a potential donor to a “Donation” page 65 as shown in FIG. 5. Donation pages may take any of a wide variety of forms, and a very simple form is provided in FIG. 5 as an example. A header 67 identifies the page as a donation page. The recipient of a donation to be made (Doris Smith) is provided just below the header. An entry field 71, which can be selected and into which, when selected, an amount may be entered, is provided for quantifying a donation for the donor. In this case a potential donor has entered $35.00 as an amount.

In this particular example a donor can select box 73 to indicate the donation should be made immediately, or box 74 to indicate the donation should be made at a later time. If box 74 is checked, a field 75 is enabled, wherein a donor may input a date for the donation to be made.

A button 69 is provided in every donation page to submit the donation to the system, and upon selection, the entry made by a donor is recorded in the system's databases, and acted upon. In some embodiments a provision is also made for a donor, having submitted a donation to be made at a future time, to revisit a donation page and to with draw a donation before it is made. Preferably, however, once a donation is submitted, the commitment is made, and the transaction will be completed on the day entered, or immediately if box 73 was checked. A person with skill in the art will recognize that the donation page can be much more extensive than the rather simple example shown.

Referring now back to FIG. 1, two financial institutions 27 and 37 are illustrated as a part of the overall infrastructure of the system of the invention. In a preferred embodiment these institutions are banks, but the concept and the invention is not limited to conventional banking institutions. It is expected that potential donors and qualified recipients of donations will have one or more bank accounts, such as checking accounts. In a preferred embodiment there is a qualification procedure for both of recipients and donors, implemented through Q&S center 16, which is described in more detail below. One step in that process is for a potential recipient or a potential donor to submit and verify a bank account from which donations from a donor will be made, and into which donations for a recipient will be deposited. In each case, the institution entered and verified, which are represented by institutions 27 and 37, need to be Internet-connected institutions capable of cooperating with the system of the invention for providing and receiving funds.

In a preferred embodiment the system of the invention maintains a special relationship with a number of financial institutions, such as banks, and offers an enhanced service to potential donors and to potential recipients, wherein the donors and recipients can open a special account at a qualified financial institution, the account facilitated by the system of the invention. Such an account allows a donor, for example, to transfer a fixed amount of money into the special donor's account, and to track and review that account through interactive pages and/or windows provided by the system of the invention. Other accounts (any kind of financial account) may be sent up in this way such as trust accounts for qualified recipients children, stock accounts, mutual fund accounts, IRA accounts etc. The donor may also set up parameters as to how the funds are to be used.

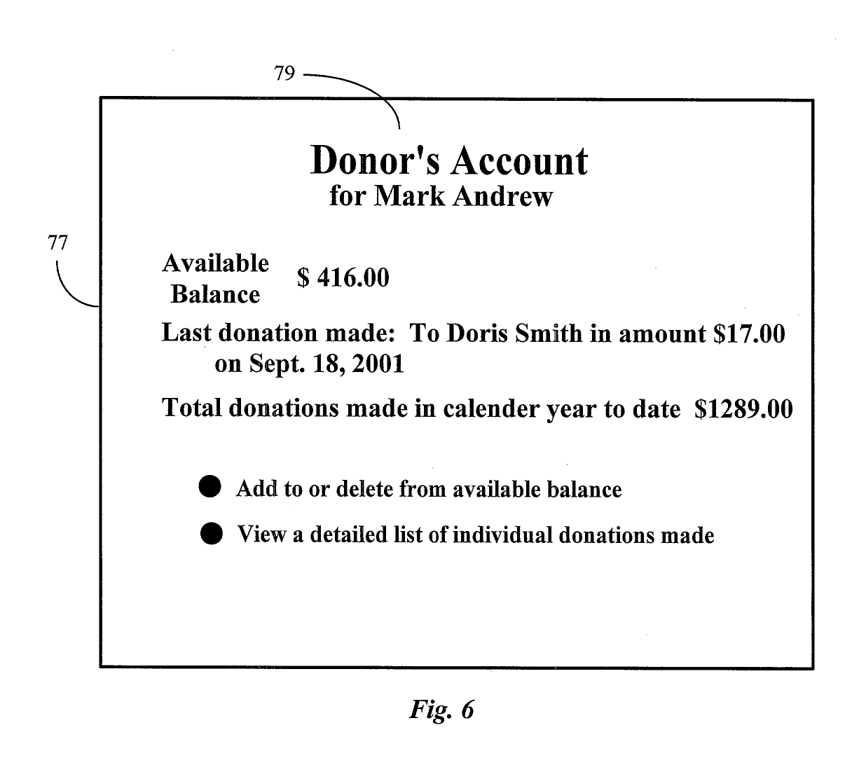

As an example, referring once again to FIG. 2, a qualified and subscribing donor may select interactive link 48 after logging in to the system, and an account page or window 77 will result, as shown in FIG. 6. In this page or window, a header 79 identifies the information as a Donor's Account for Mark Andrew. An available balance in the account for making further donations is listed as $416.00. The last donation made is listed, in this case to Doris Smith for $17.00 on Sep. 18, 2001, and the total donations for the calendar year are listed.

Also on page 77 there are two interactive buttons: One of these enables a new page or window for the particular donor to add to or delete from the available balance. In this case a page is presented, not depicted in this specification, in which the individual may transfer money to or from another account or source electronically into or out of the Donor's Account. A second interactive button takes the donor to a page, also not depicted in this specification, that lists all details of donations made. These two windows or pages are not presented or described in detail, because they do not differ materially from such pages known in the art and used for on-line banking in general.

Although the only place an access button is shown for a donor to access his or her special account is in FIG. 2, it will be clear to the skilled artisan that such an interactive button may be included in many or all of the pages that a donor may access and use.

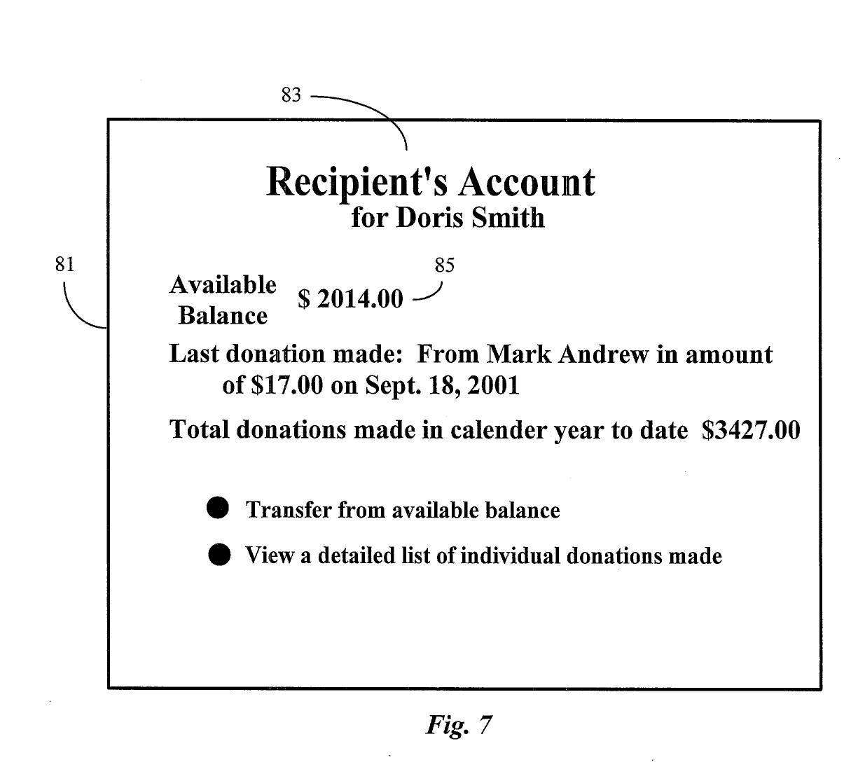

Special accounts are also made available in the system for qualified recipients. When a qualified recipient, who also will have a user name and password, logs in, the first page presented to the recipient is different than page 47 presented to donors and to casual browsers. The log in will identify the recipient, and a page like page 81 of FIG. 7 is presented. In page 81 a header 83 identifies the page as a Recipient's account statement, and a smaller header identifies the account holder, in this case Doris Smith. There is a listing 85 for available balance, the date, source, and amount of the last donation made, and the total of donations made into the account for the calendar year to date.

Also on page 81 there are interactive links for enabling the account holder to transfer money from the available balance into another account, and to view a detailed list of individual donations made to the account. Again, as above, because these lower-order pages are very similar to on-line banking forms and the like, no detailed description is made here. Such pages can take any one of many forms.

At this point in the description of this unique invention some of the features which render the invention unique and valuable should be quite clear. For example, by this system, potential donors can now gain access to details of individual persons and families associated with certain disasters and other projects, and can now make contributions directly and immediately to those particular qualified recipients that meet their own particular criteria for giving. The donation, as mentioned above, can be accomplished immediately, and the money donated goes directly to the selected person, family or organization. There is no pooling of funds at an intermediate point, requiring “management” by any third party. The potential donor can now be assured that all of the donated money is going directly to the person, family or organization selected.

On the part of qualified recipients, there is no need to depend on anonymous managers for doling out portions of donated funds, and access to donations meant for the particular recipient is also immediate. These features largely solve some of the biggest problems described in the “Background” section above.

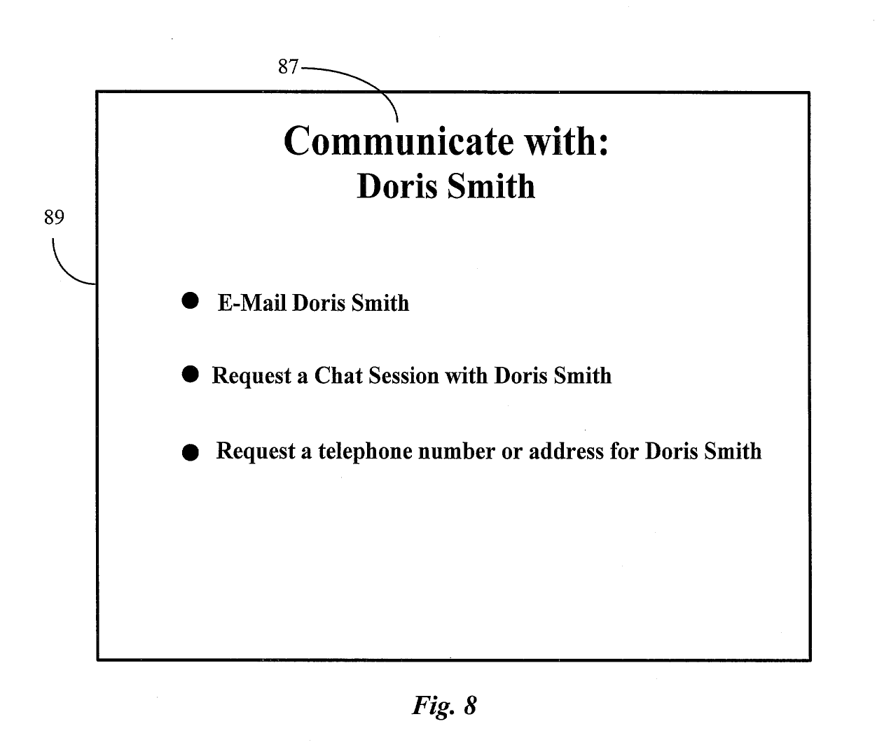

Further to the above, it is an object of the present invention to enable direct communication between donors and recipients, if both are amenable. For example, referring now back to FIG. 4, which is an information page provided for Doris Smith, there may be, in addition to the interactive link 63 for making a donation, another interactive link 64 for requesting communication with the qualified recipient. A potential donor may want such communication to elicit other information not shown, to resolve an issue or problem, or any other of many possible reasons. Upon selecting link 64 the donor is presented with a page or window 89 as shown in FIG. 8 for establishing communication with a recipient, in this example Doris Smith. In the exemplary page 89 there are three interactive links, one for e-mail, one for Chat, and one for information enabling a direct telephone call or conventional letter to Doris Smith.

In response to selection of the e-mail link, the system provides an e-mail client input form allowing the donor to type in a message, a from e-mail address, and so forth, as is known in the art, and there is a Send link to send the finished e-mail to Doris Smith. Alternatively, Doris Smith's e-mail address is provided, and the donor may then use his/her own e-mail client to send a message separate from the system of the invention.

In response to selecting a chat session, the request will be forwarded to Doris Smith, who may then respond with a message as to when she will be online for chat.

In response to selecting a telephone number or address, the system, if previously authorized by Doris Smith will temporarily post, only on the requesting donor's temporary communication page, the pertinent address and/or telephone number.

If a donor has requested communication with a recipient, such as Doris Smith in this example, and the request requires a reply from Doris Smith, when Doris Smith enters her reply, a message icon is caused to appear on whatever page or window the donor happens to be viewing, and upon selecting the icon, the message is displayed just to the requesting donor. The system to accomplish this messaging tracks the activity of the donors accessing the service, and which pages or windows are currently active for each donor. As an example, a message icon is shown as element 52 in FIG. 2, informing the donor of a message from Doris Smith.

It may also be that an individual recipient does not wish direct contact, and in the configuration process associated with Q&S center 16 (see FIG. 1), yet to be described in full, a potential recipient may request “No Communication”, which will become a part of that person's profile. In the case of such a request for privacy the system will inform any person attempting to communicate with Doris Smith that Doris Smith has requested no communication.

Referring now back to FIG. 1, there is, as described briefly above, a communication and structure (Q&S) facility 16 in the infrastructure of the system of the invention. The purpose of the Q&S facility is to monitor and update the look and feel and the structure of the service through server 13. The depiction of facility 16 as a specific block with a single high-speed link to server 13 is exemplary only. The functions of this facility may be fully integrated with server 13, or may be diversified over several locations, each linked to server 13, or may even be accomplished one or several individual computer stations with Internet access. The point to be made is that old projects will need to be terminated, new projects will need to be added, recipients will need to be added, qualified, and occasionally deleted, donors will need to be qualified, accounts will need to be updated, and so forth. The service will be in a constant state of flux, and will never be static for any extended period.

The functions of deleting projects, adding projects, and the like, are functions of Web page maintenance that are well known in the art, and need not be described in enabling detail in this specification. The skilled artisan is aware of the ways in which this sort of work is done.

The functions of qualification, particularly of qualifying recipients in projects, will be a relatively complicated process requiring, in many cases, agents which may interview applicants, and perform a certain amount of research to qualify the applicants. In FIG. 1 the stations that applicants and donors use are shown connected by telephone lines (23 and 25) to Q&S center 16, and communicants may use either computers or telephones. Although not shown, recipients may also communicate by mail and e-mail, and information forms may be by mail from the Q&S, or as attachments to e-mail. There are many possibilities. There is also the matter of preparing recipients information profiles which will be presented to potential donors. These tasks will require knowledge workers with a certain amount of training, and may be performed preferably by volunteers. In a preferred embodiment the functions of these workers is open to public scrutiny, and a facility is provided for third party input to obviate fraud.

In one optional configuration, no research is done, and recipients are accepted on their word after providing a certain amount of information, but a delay is put on withdrawal of donations into assigned accounts, and the recipients are advertised on the service as new recipients, so third parties will have an opportunity to investigate legitimacy. The inventors believe the qualification of recipients may be done quickly and simply and reliably, through a process of evolution once such a service is made available, and, through the openness and accessibility of the system, fraud can be kept relatively non-existent. It is an object of the invention to greatly facilitate the ability of all citizens to interact generously with those in need of immediate aid, without the problems of middle men and organizations, which create a temptation to self-serving ends.

It will be apparent to the skilled artisan that there is no real limitation to the nature of projects in the system of the invention, and the kinds of projects that have been exemplified up to this point in the specification are not meant to illustrate a limitation to the invention.

In an alternative embodiment a service is provided for homeless persons and others in need of aid, in which potential donors may be selective in the kind of aid that is provided, and may in fact select to provide several sorts of non-cash aid. In the case of those people who are broadly termed homeless in this country, there is a concern on the part of many that cash aid may be used for drug and alcohol abuse, rather than for food, education, housing, and the sorts of things that potential donors may believe to be more helpful.

In this particular embodiment, providing non-cash aid, one mechanism is to establish a project, for example for homeless people, which may be segregated by region or by city. Potential recipients may apply to Q&S facility 16 to be certified as qualified recipients, and after qualification may be entered with profiles in the databases of the system. In this embodiment cards are made available to be selected by donors and provided to qualified recipients. The cards, in one option, are made much like what were once known as “meal tickets” or “trolley tickets”. Such cards are purchased for one price, and typically have smaller amounts printed around the periphery of the card which may be punched out to “spend” the punched amount. The total of the printed amounts is equal to, or in some cases a bit greater, than the purchase price.

Alternatively to punch cards, modern smart cards may be provided wherein amounts may be electronically deducted until a total amount is met. In preferred embodiments a mechanism is provided to prevent the common work-around for such a scheme, wherein cards are discounted for cash to third parties, who then use the cards for the full amount. To prevent this sort of work-around, in the qualification process recipients are provided with a separate one-time card with virtual identity. This card provides a code, not necessarily a real identification, which must be provided with a benefit card each time the benefit card is used. A recipient may still give away the ID card when discounting a benefit card, but that would be a one-time-only dodge.

The skilled artisan will be aware that there are a variety of ways the functionality taught in this application may be provided. For example, the Web pages and windows used as examples are over-simplified, and such pages may be much richer in content, color and graphics. The infrastructure illustrated in the several embodiments may be implemented in a variety of ways as well. There are other variations that may be made without departing from the spirit and scope of the invention. The invention should be accorded the scope of the claims that follow.

1-24. (canceled)

25. A financial aid system, comprising:
an Internet-connected server accessible by potential donors using an Internet browser;
a data repository coupled to the server, storing profiles describing individuals, each profile describing needs of the associated individual, and deposit data for an account controlled solely by the associated individual;
wherein a potential donor is enabled to select one or more profiles about individuals, and to make a deposit to the account controlled by that individual.
